(19) United States
(12) Patent Application Publication
(10) Pub. No.: US 2013/0049953 A1
(43) Pub. Date: Feb. 28, 2013

(54) Alarm system

(71) Applicants: David Bailey, Riverview, FL (US); Vic Granowicz, Apollo Beach, FL (US)

(72) Inventors: David Bailey, Riverview, FL (US); Vic Granowicz, Apollo Beach, FL (US)

(21) Appl. No.: 13/199,254

(22) Filed: Aug. 24, 2011

(51) Int. Cl. G08B 13/14; G08B 1/08

(52) U.S. Cl. 340/539.11; 340/568.1

(57) ABSTRACT

An alarm system for use with an existing audible sound generator such as a vehicle horn or alarm, building alarm or stand alone or self-contained audio alarm comprising a remote alarm signal generator mounted on or attached to a movable object to be protected against undetected movement including an alarm sensor/transmitter system having a signal generator to generate and transmit an alarm signal to an audible signal generator operatively coupled to the existing audible sound generator including a receiver system having a signal generator to receive the alarm signal from the remote alarm signal generator and to generate a signal to actuate the existing audible sound generator when the alarm sensor/transmitter system senses a condition such as motion or a change in signal strength below or above a predetermined threshold level.

### BACKGROUND OF THE INVENTION

1. Field of the Invention

An alarm system to activate an existing sound generator when an object upon which the alarm system is moved.

2. Description of the Prior Art

Seemingly limitless systems have been developed to protect homes, offices, automobiles and the like from unlawful entry or theft by security alarms.

However, there is a need to protect relatively small objects and other items easily moved. This is particularly true when the items are remotely located.

### SUMMARY OF THE INVENTION

The present invention relates to an alarm system for use with an existing audible sound generator comprising at least one remote alarm signal generator mounted on or attached to a movable object such as an ATV (all terrain vehicle) and an audible signal generator operatively coupled to an existing audible sound generator such as a vehicle horn.

The remote alarm signal generator includes an alarm sensor/transmitter system having a signal generator to generate and transmit an alarm signal to the audible signal generator including a radio frequency receiver system including a signal generator to receive the alarm signal from the remote alarm signal generator and to actuate the existing audible sound generator of the vehicle to generate an audible alarm when the alarm sensor/transmitter system senses a condition such as motion or signal strength change below or above a predetermined threshold level.

The remote alarm signal generator comprises a microprocessor including logic and timing to control the operation of the remote alarm signal generator. Operatively coupled to the microprocessor are control keys or buttons, a LED indicator and radio frequency transmitter.

The audible signal generator comprises a microprocessor including logic and timing to control the operation of the audible signal generator. Operatively coupled to the microprocessor are an LED display and a switch or control key along with a radio frequency receiver.

The audible signal generator may be armed or disarmed at the remote alarm signal generator or the audible signal generator through the use of the control key or button and the switch or control key. The audible signal generator can be armed only when the remote alarm signal generator is inactive. The remote alarm signal generator is activated and inactivated through the use of the control keys or buttons.

Once the audible signal generator is energized and the vehicle horn sounds, the vehicle horn can be silenced at the remote alarm signal generator or at the audible signal generator.

When more than one remote alarm signal generator is to be activated, each remote alarm signal generator needs to be paired with the audible signal generator. The remote alarm signal generator must be deactivated and the audible signal generator disarmed to allow pairing through the use of the control keys or buttons.

A particular series of predetermined input control signal patterns control the operational status or states of the remote alarm signal generator and the audible sound generator.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 depicts the alarm system of the present invention for use with a vehicle horn or alarm.

FIG. 2 depicts an alternate embodiment of the alarm system of the present invention for use with a vehicle horn or alarm.

FIG. 3 is a block diagram of the remote alarm signal generator of the present invention.

FIG. 4 is a block diagram of the audible signal generator of the present invention.

FIG. 5 is a schematic diagram of the remote alarm system generator of the present invention.

FIG. 6 is a schematic diagram of the audible signal generator of the present invention.

Similar reference characters refer to similar parts throughout the several views of the drawings.

### DETAILED DESCRIPTION OF THE PREFERRED EMBODIMENT

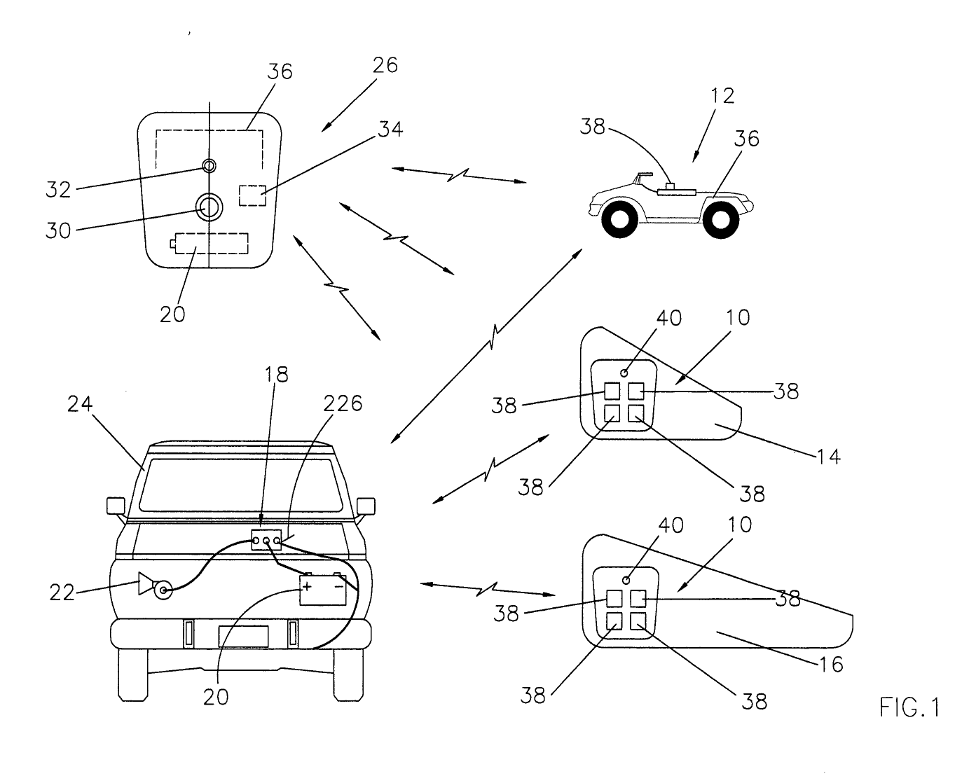

The present invention relates to an alarm system for use with an existing audible sound generator. As shown in FIG. 1, the alarm system comprises at least one remote alarm signal generator generally indicated as 10 mounted on or attached to a movable object such as an ATV (all terrain vehicle) 12, a pistol and case or other relatively small valuable item 14 or a rifle and case or other valuable item such as a fishing rod and reel 16 and an audible signal generator generally indicated as 18 operatively coupled to the battery 20 and an existing audible sound generator such as a horn 22 of a vehicle 24. Of course, the audible sound generator may comprise an existing house alarm (not shown) or self-contained audio alarm (not shown).

As described more fully hereinafter, the remote alarm signal generator 10 includes an alarm sensor/transmitter system having a signal generator to generate and transmit an alarm signal to the audible signal generator 18 including a radio frequency receiver system including a signal generator to receive the alarm signal from the remote alarm signal generator 10 and to actuate the existing audible sound generator 22 of the vehicle 24 to generate an audible alarm when the alarm sensor/transmitter system senses a condition such as motion or signal strength change below or above a predetermined threshold level.

In addition, a battery powered pager generally indicated as 26 may be linked to the remote alarm signal generators 10. As shown in FIG. 1, the battery powered pager 26 includes a battery power source, a sound generator, an LED indicator, a radio frequency receiver and an antenna indicated as 28, 30, 32, 34 and 36 respectively. Each of the remote alarm signal generators 10 includes an input device such as a key pad with a plurality of control keys on buttons each indicated as 38 and an LED indicator 40.

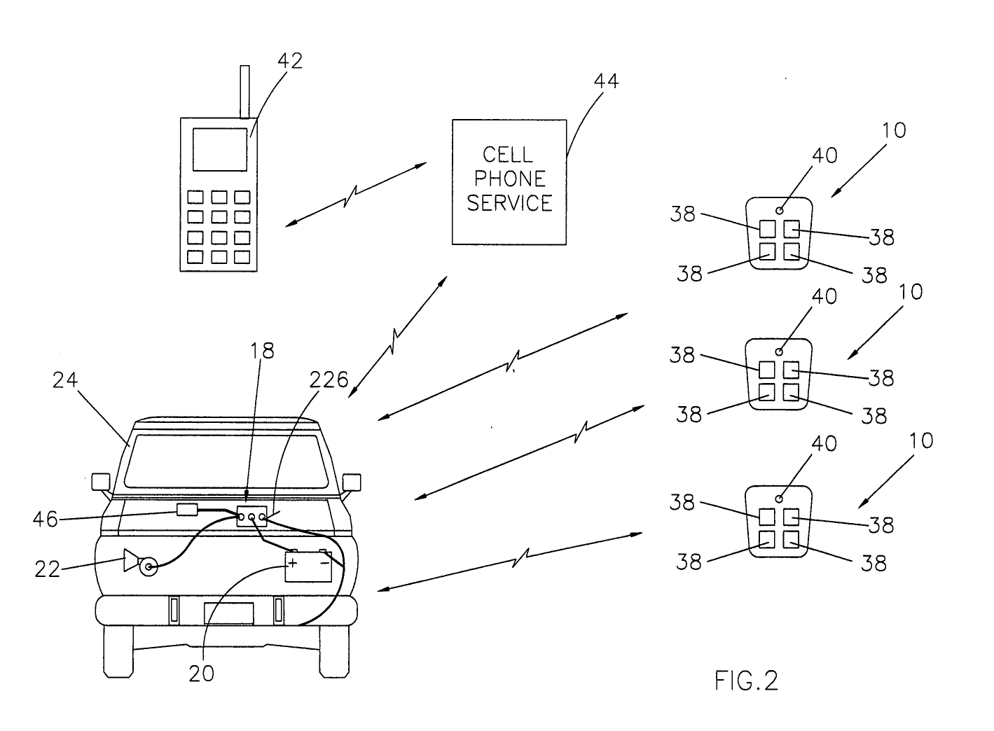

FIG. 2 depicts an alternate embodiment of the alarm system with similar components and systems similarly designated. Specifically, the remote alarm signal generator 10 includes an alarm sensor/transmitter system having a signal generator to generate and transmit an alarm signal to the audible signal generator 18 including a radio frequency receiver system including a signal generator to receive the alarm signal from the remote alarm signal generator 10 and to actuate the existing audible sound generator 22 of the vehicle 24 to generate an audible alarm when the alarm sensor/transmitter system senses a condition such as motion or signal strength below or above a predetermined threshold level. In addition, a battery powered cell phone generally indicated as 42 is linked between the remote alarm signal generators 10 and the audible signal generator 18 by a cell phone system 44 and an onboard cell phone receiver/transmitter 46.

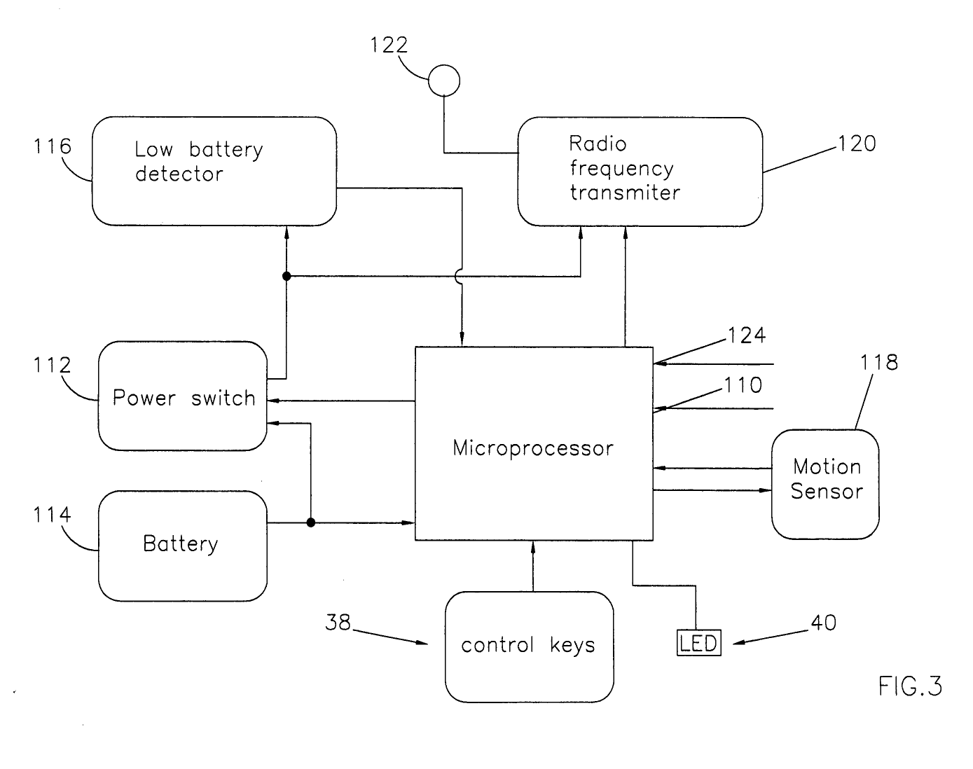

FIG. 3 is a block diagram of the remote alarm signal generator 10 functional components. Specifically, the remote alarm signal generator 10 comprises a microprocessor 110 including logic and timing to control the operation of the remote alarm signal generator 10. Operatively coupled to the microprocessor 110 are the control keys or buttons 38 of the key pad and the LED indicator 40 as well as a power switch, a battery, a low battery detection, a motion sensor accelerometer and a radio frequency transmitter indicated as 112, 114, 116, 118 and 120 respectively. The remote alarm signal generator 10 further includes an antenna 122 and a programming interface 124.

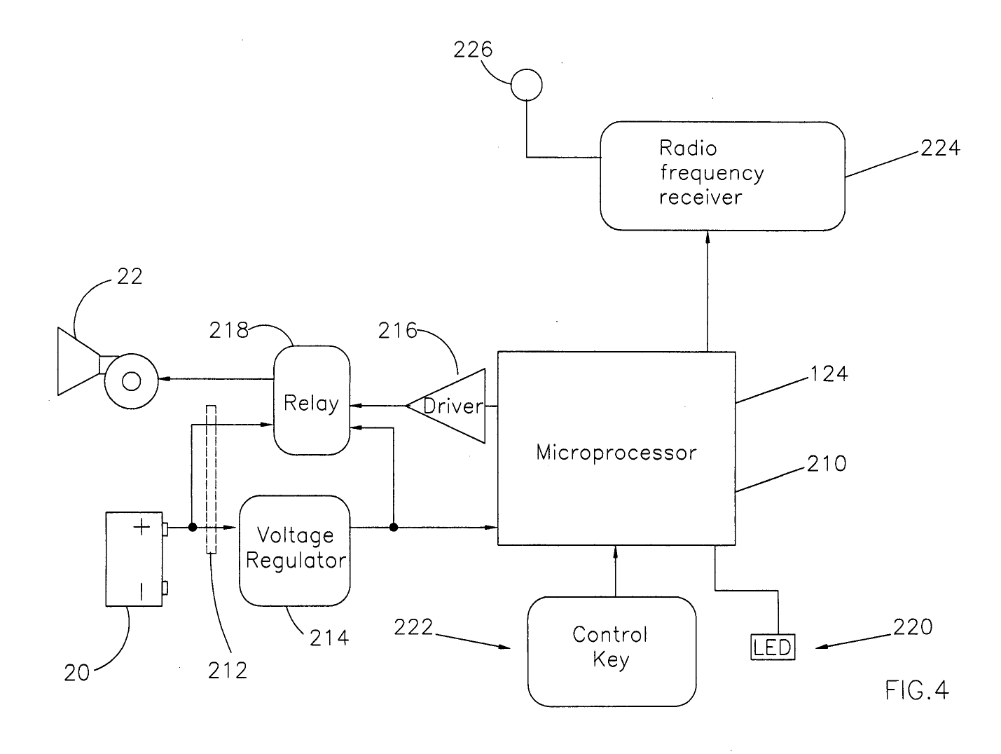

FIG. 4 is a block diagram of the audible signal generator 18 functional components. Specifically, the audible signal generator 18 comprises a microprocessor 210 including logic and timing to control the operation of the audible signal generator 18. Operatively coupled to the microprocessor 210 are the battery 20 and the horn 22 through wire harness 212, a low voltage regulator 214 and an alarm drive 216 and relay 218 as well as an LED display 220 and a switch or control key 222 along with a radio frequency receiver 224 and antenna 226.

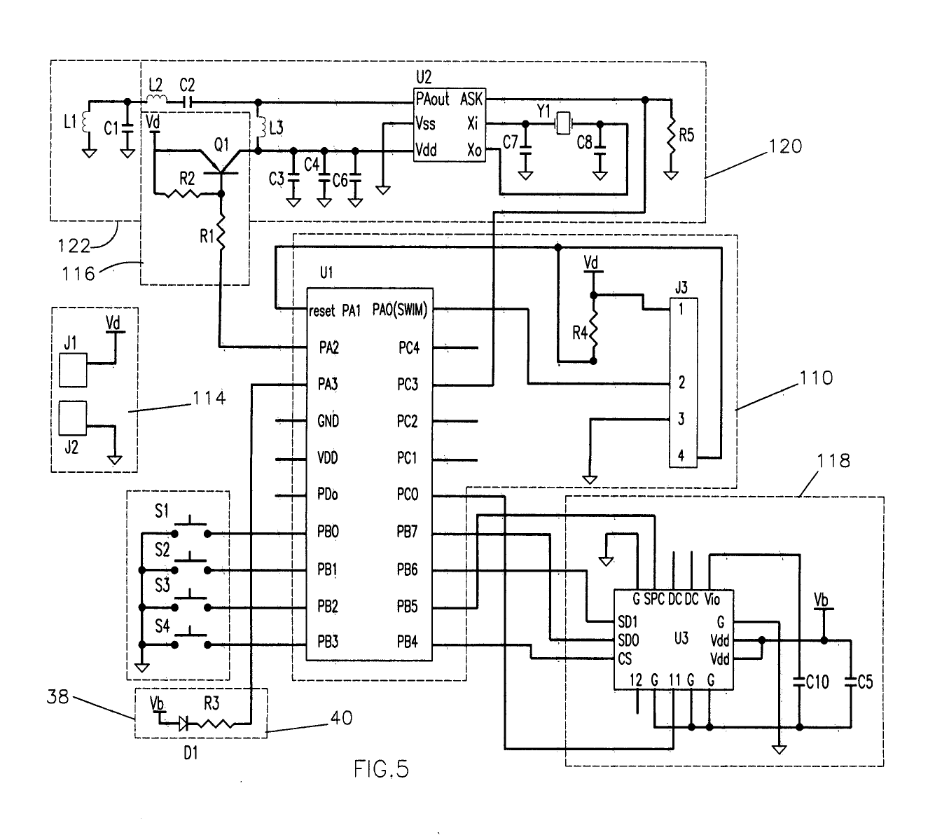

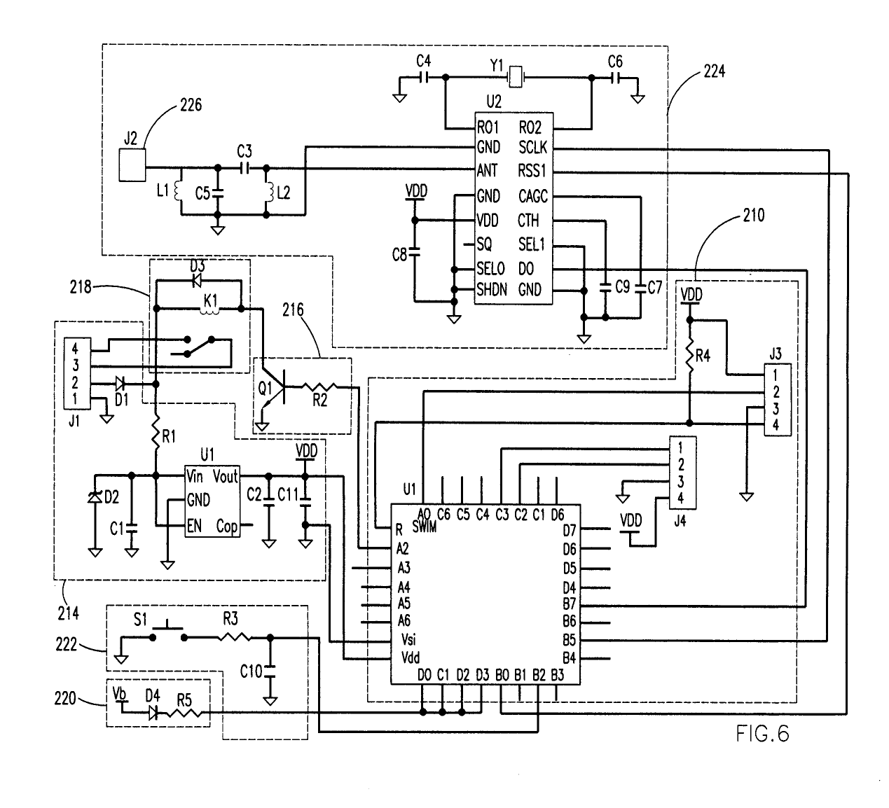

FIGS. 5 and 6 show the circuit details that complement the functional component describes of FIGS. 3 and 4 respectively.

The audible signal generator 18 may be armed or disarmed at the remote alarm signal generator 10 or the audible signal generator 18 through the use of the control key or button 38 and the switch or button 222 respectively. The audible signal generator 18 can be armed only when the remote alarm signal generator 10 is inactive. The remote alarm signal generator 10 is activated and inactivated through the use of the control keys or buttons 38 as described below.

Once the audible signal generator 18 is energized and the vehicle horn 22 sounds, the vehicle horn 22 can be silenced at the remote alarm signal generator 10 or at the audible signal generator 18 as described below.

When more than one remote alarm signal generator 10 is to be activated, each remote alarm signal generator 10 needs to be paired with the audible signal generator 18. The remote alarm signal generator 10 must be deactivated and the audible signal generator 18 disarmed to allow pairing through the use of the control keys or buttons 38 as described below.

The motion sensitivity can be changed using the control keys or button 38 of the remote alarm signal generator 10 as described below. Furthermore, the remote alarm signal generator 10 PIN numbers can be changed using the control keys or buttons 38.

The remote alarm signal generator 10 and audible signal generator 18 firm ware is programmed as described below.

The alarm system is operable only when the remote alarm signal generator 10 is activated and the audible signal generator 18 is armed.

The particular series of predetermined input control signal patterns control the operational status or states of the remote alarm signal generator 10 and the audible sound generator 18 are set forth below.

### Arming and Disarming the Audible Sound Generator 18:

### At Remote Alarm Signal Generator 10

Remote Alarm Signal Generator 10 must be inactive to system ARM/DISARM
Enter 4 digit. PIN number followed by fifth digit:
   Press 1 key to Arm the Audible Signal Generator 18 (system), Audible Signal Generator 18 chirps vehicle horn once for 0.1 second
   Press 2 to key Disarm the Audible Signal Generator 18 (system), Audible Signal Generator 18 chirps vehicle horn twice for 0.1 second (0.5 second in-between)
Remote Alarm Signal Generator 10 flashes LED red for 0.5 second on 0.5 second off and green 0.5 second off pattern upon successful transmission
   Acknowledgment of system ARM or DISARM is by vehicle horn and Audible Signal Generator 18 status LED.

### At Audible Signal Generator 18

Audible Signal Generator 18 flashed status LED for 0.1 second at 1 second interval to indicate Armed status
Press and hold Audible Signal Generator 18 button switch for 5 seconds to toggle between ARM and DISARM modes
   Arming the system Audible Signal Generator 18, Audible Signal Generator 18 chirps vehicle horn once for 0.1 second
   Disarming the system Audible Signal Generator 18, Audible Signal Generator 18 chirps vehicle horn twice for 0.1 second (0.5 second in-between)

### Activating Remote Alarm Signal Generator 10:

Enter 4 digit PIN number within 10 seconds
Remote Alarm Signal Generator 10 flashes LED green to acknowledge then four flashes then (red if battery good or yellow if battery low) for 10 seconds and 0.5 second on and 0.5 second off pattern
Error in PIN entry, Remote Alarm Signal Generator 10 flashes LED green one 0.5 second flash
Remote Alarm Signal Generator 10 sends enable signal to Audible Signal Generator 18, Audible Signal Generator 18 chirps vehicle horn for 0.1 second
Remote Alarm Signal Generator 10 delays arming motion detect for 10 seconds while activation LED is flashing
System is active with this Remote Alarm Signal Generator 10. At least ten (10) Remote Alarm Signal Generator 10 s may be activated on the system.

### Deactivating Remote Audible Signal Generator 10:

PIN number's first digit must be entered correctly within 4 seconds of movement of the Remote Alarm Signal Generator 10.
Enter complete 4 digit PIN number within 20 seconds
Remote Alarm Signal Generator 10 flashes LED green one 0.5 second flash and if battery low follow with flashing LED yellow for 5 seconds and 0.5 second on and 0.5 second off pattern
Remote Alarm Signal Generator 10 sends inactivating signal to Audible Signal Generator 18
If incorrect PIN is entered, Remote Alarm Signal Generator 10 LED flash green for 0.5 second and then allows a new PIN to be entered within 10 seconds. If the second PIN number is entered incorrectly or 10 seconds occurs, Remote Alarm Signal Generator 10 sends the Alarm Event code.
Each Remote Alarm Signal Generator 10 must be individually inactivated

### Silencing Vehicle Horn 22:

### Remote Alarm Signal Generator 10

Remote Alarm Signal Generator 10 must be active to silence horn
Enter 4 digit PIN number to deactivate Remote Alarm Signal Generator 10 and silence horn

### Audible Signal Generator 18

Press Audible Signal Generator 18 button switch, while horn 22 is sounding terminates alarm
   Audible Signal Generator 18 Armed mode does not change
   Pairing Remote Alarm Signal Generator 10 with Audible Signal Generator 18:
Audible Signal Generator 18 must be Disarmed and Remote Alarm Signal Generator 10 Inactive to allow programming
Momentarily press Audible Signal Generator 18 button switch (not more than 3 seconds), Audible Signal Generator 18 LED lights for 20 seconds or terminates with a double flash upon successful pairing operation
PAIRING—Press Remote Alarm Signal Generator 10 1 key and hold until Audible Signal Generator 18 LED signals successful pairing with a double flash (0.5 second on and 0.5 second off pattern) upon, or
UN-PAIRING—Press Remote Alarm Signal Generator 10 2 key and hold until Audible Signal Generator 18 LED signals successful un-pairing with a single 0.5 second flash upon
Up to 10 Remote Alarm Signal Generator 10 s may be paired with a Audible Signal Generator 18

### Changing Sensitivity of Remote Alarm Signal Generator 10:

Enter existing PIN number. Remote Alarm Signal Generator 10 green LED flashes 0.5 second once to acknowledge. If an invalid existing PIN number is entered, Remote Alarm Signal Generator 10 flashes red LED once for 0.5 second
Press Remote Alarm Signal Generator 10 4 key.
Remote Alarm Signal Generator 10 green LED flashes 0.5 second once to acknowledge. Enter a new sensitivity number (1 to 4, 1 is most sensitive and 4 is the least sensitive, Default is 2), Remote Alarm Signal Generator 10 green LED flashes 0.5 second once to acknowledge
If a 10 seconds time out occurs Remote Alarm Signal Generator 10 flashes red LED once for 0.5 second and sensitivity number change sequence is terminated
   Changing Remote Alarm Signal Generator 10 PIN number:
Enter existing PIN number
Press Remote Alarm Signal Generator 10 3 key.
Remote Alarm Signal Generator 10 green LED flashes 0.5 second once to acknowledge. If an invalid existing PIN number is entered, Remote Alarm Signal Generator 10 flashes red LED once for 0.5 second and PIN number change sequence is terminated
Enter new PIN number, Remote Alarm Signal Generator 10 green LED flashes 0.5 second once to acknowledge
If a 10 seconds time out occurs Remote Alarm Signal Generator 10 flashes red LED once for 0.5 second and PIN number change sequence is terminated

### Remote Alarm Signal Generator 10 Firmware:

Uses microcontroller ID number for unique MAC address (use 24 bits)
Default PIN number “1234”
Entering PIN number entry timing window is 10 seconds
Installing a battery with the 3 key pressed restores the Default PIN number
Remote Alarm Signal Generator 10 stores state when Remote Alarm Signal Generator 10 is activated for monitoring
Remote Alarm Signal Generator 10 sends activating code to Audible Signal Generator 18 each time activated.
Remote Alarm Signal Generator 10 sends alarm event code to Audible Signal Generator 18 upon valid motion detect
Motion is qualified for ten seconds to validate
Remote Alarm Signal Generator 10 sends inactivating code to Audible Signal Generator 18
When motion is detected Remote Alarm Signal Generator 10 allows up to 10 seconds for first digit of PIN number to be entered before sending alarm event code
Remote Alarm Signal Generator 10 sends alarm event code to Audible Signal Generator 18 upon invalid PIN sequence detected

### Audible Signal Generator 18 Firmware:

Audible Signal Generator 18 chirps horn for 0.1 seconds upon receiving activation code and is set to Armed mode
Audible Signal Generator 18 enables horn in 1 second on and 1 second off pattern for 20 seconds upon receiving alarm event code or terminated is any paired Remote Alarm Signal Generator 10 sends inactivate signal
Pressing a Remote Alarm Signal Generator 10 key for more than 3 seconds toggles between Arm and Disarm modes
Audible Signal Generator 18 defaults to Armed mode when powered up.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. An alarm system for use with an existing sound generator comprising a remote alarm signal generator mounted on or attached to a movable object to be protected against undetected movement including an alarm sensor/transmitter system having a signal generator to generate and transmit an alarm signal to an audible signal generator operatively coupled to the existing sound generator including a receiver system having a signal generator to receive the alarm signal from the remote alarm signal generator and to generate a signal to actuate the existing sound generator when said alarm sensor/transmitter system senses motion.

2. The alarm system of claim 1 wherein a cell phone is linked between the remote alarm signal generators and the audible signal generator by a cell phone system and an onboard cell phone receiver/transmitter operatively coupled to the existing sound generator.

3. The alarm system of claim 1 wherein said remote alarm signal generator comprises a microprocessor including logic and timing to control the operation of said remote alarm signal generator operatively coupled to said microprocessor and a motion sensor accelerometer to selectively generate said alarm signal and a radio frequency transmitter to transmit said alarm signal and said audible signal generator comprises a microprocessor including logic and timing to control the operation of said audible signal generator, operatively coupled to a radio frequency receiver to receive said alarm signal and generate a signal to activate the existing sound generator upon receiving said alarm signal from said remote alarm signal generator.

4. The alarm system of claim 3 wherein said alarm system is operable only when said remote alarm signal generator is activated and said audible signal generator is armed.

5. The alarm system of claim 4 wherein said audible signal generator is selectively armed or disarmed at said remote alarm signal generator when said remote alarm signal generator is inactive.

6. The alarm system of claim 5 comprising more than one remote alarm signal generator individually paired with said audible signal generator.

7. The alarm system of claim 6 wherein said remote alarm signal generator must be deactivated and said audible signal generator disarmed to allow pairing.

8. The alarm system of claim 7 wherein said audible signal generator is armed by activating a control key for a predetermined period followed by chirp of vehicle horn once and is disarmed by activating said control key for a second period followed by a second chirp of vehicle horn one then one time.

9. The alarm system of claim 8 wherein arming said audible signal generator is followed by an audible sound of a predetermined number of times and disarming said system audible signal generator, audible signal generator is followed by an audible sound of a second predetermined time.

10. The alarm system of claim 8 wherein activating remote alarm signal generator: enter 4 digit pin number within 10 seconds, remote alarm signal generator flashes led green to acknowledge then four flashes then (red if battery good or yellow if battery low) for 10 seconds and 0.5 second on and 0.5 second off pattern; error in pin entry, remote alarm signal generator flashes led green one 0.5 second flash; remote alarm signal generator sends enable signal to audible signal generator, audible signal generator chirps vehicle horn for 0.1 second; remote alarm signal generator delays arming motion detect for 10 seconds while activation led is flashing; system is active with this remote alarm signal generator at least ten (10) remote alarm signal generator 10 s may be activated on the system.

11. The alarm system of claim 10 wherein deactivating audible signal generator: PIN number's first digit must be entered correctly within 4 seconds of movement of the remote alarm signal generator; enter complete 4 digit PIN number within 20 seconds; remote alarm signal generator flashes led green one 0.5 second flash and if battery low follow with flashing led yellow for 5 seconds and 0.5 second on and 0.5 second off pattern.

12. The alarm system of claim 8 wherein remote alarm signal generator sends inactivating signal to audible signal generator: if incorrect PIN is entered, remote alarm signal generator led flash green for 0.5 second and then allows a new PIN to be entered within 10 seconds, if the second PIN number is entered incorrectly or 10 seconds occurs, remote alarm signal generator sends the alarm event code; each remote alarm signal generator must be individually inactivated.

13. The alarm system of claim 10 wherein silencing vehicle horn; remote alarm signal generator; remote alarm signal generator must be active to silence horn; enter 4 digit PIN number to deactivate remote alarm signal generator and silence horn.
